(19) United States
(12) Patent Application Publication
(10) Pub. No.: US 2024/0412638 A1
(43) Pub. Date: Dec. 12, 2024

(54) VEHICLE

(71) Applicant: Hitachi Astemo, Ltd., Hitachinaka-shi, Ibaraki (JP)

(72) Inventors: Tetsuya YAMADA, Chiyoda-ku, Tokyo (JP); Masashi SEIMIYA, Chiyoda-ku, Tokyo (JP)

(73) Assignee: Hitachi Astemo, Ltd., Hitachinaka-shi, Ibaraki (JP)

(21) Appl. No.: 18/697,513

(22) PCT Filed: Aug. 22, 2022
(86) PCT No.: PCT/JP2022/031533

§ 371 Date: Apr. 1, 2024

(30) Foreign Application Priority Data
Oct. 7, 2021 (JP) 2021-165770

(51) Int. Cl. G08G 1/16; B60W 10/18; B60W 30/09; B60W 30/095; B60W 50/14

(52) U.S. Cl. CPC G08G 1/167; B60W 10/18; B60W 30/09; B60W 30/0953; B60W 50/14; B60W 2050/143; B60W 2300/14; B60W 2520/22; B60W 2530/205; B60W 2554/4048; B60W 2754/10

(57) ABSTRACT

The vehicle 1 includes a tow vehicle 2 and a loading platform 3. The loading platform 3 includes a ROM 23 storing loading platform information including a loading platform type and a plurality of first external sensors 8 that detect an object around the loading platform 3. The tow vehicle 2 acquires the loading platform type from the loading platform 3 and includes an ADAS ECU 10 that performs a driving assist of the vehicle 1 based on the acquired loading platform type and a plurality of second external sensors 9 that detect an object around the tow vehicle 2. The ADAS ECU 10 converts the acquired detection data of each of the first external sensors 8 from a sensor coordinate system of each first external sensor to a loading platform coordinate system, further converts from the loading platform coordinate system to the tow vehicle coordinate system, integrates detection data of the first external sensor 8 and detection data of the second external sensor 9 into the tow vehicle coordinate system, and calculates the relative position and the relative speed of the detected object based on the integrated detection data.

### TECHNICAL FIELD

The present invention relates to a vehicle including a tow vehicle and a loading platform.

The present application claims priority based on Japanese Patent Application No. 2021-165770 filed on Oct. 7, 2021, the contents of which are incorporated herein by reference.

### BACKGROUND ART

A vehicle including a tow vehicle (tractor) and a loading platform (trailer) couples the tow vehicle and loading platform via a coupler provided on the tow vehicle and a king pin provided on the loading platform. The vehicle may be large or very large depending on a size of the loading platform. Accidents involving the large truck or the very large vehicle include an accident with entrapment at an intersection, an accident due to a lane-change, and a rollover accident when traveling around a curve, with the highest incidence of entrapment at intersections.

To prevent the accidents described above, an increasing number of vehicles are now equipped with a blind spot warning function. As disclosed in Patent Literature 1, a technology has been developed to achieve a safe operation of a vehicle by detecting an obstacle therebehind by installing an external sensor, such as a camera or a radar in a vehicle entry prevention device (Mansfield bar) placed at an extreme rear of a loading platform to prevent a passenger vehicle from entering into a bottom of the loading platform. Furthermore, as illustrated in Patent Literature 2, a technology has been developed in which a plurality of cameras are installed on a loading platform to capture images around the loading platform, and when parking in the rear, a parking assist is performed using a surrounding image around the loading platform captured by the cameras.

### CITATION LIST

### Patent Literature

Patent Literature 1: US 2019/0235519 A1
Patent Literature 2: US 2017/0341583 A1

### SUMMARY OF INVENTION

### Technical Problem

However, such vehicles need to be flexible enough to accommodate loading platforms of different lengths, widths, weights, number of tires, number of external sensors, brake systems, and the like in a single tow vehicle. Since the conditions of vehicles vary greatly depending on the type of loading platform being towed, the techniques disclosed in the above-described Patent Literatures cannot fully accommodate different types of loading platforms, thus limiting safe operation. For example, since the technology disclosed in Patent Literature 1 is limited to the installation location of the external sensor on the loading platform side to the vehicle entry prevention device, there is a problem that the technology cannot be applied when the external sensors are installed on the side and front of the loading platform. Meanwhile, the technology disclosed in Patent Literature 2 allows any number of cameras to be installed at any location on the loading platform, but since installation positions of the cameras on the loading platform side are unknown, it is necessary to determine the relative positions of the rear camera and each camera on the loading platform side by performing a calibration that compares the feature points of the images from the rear camera installed on the tow vehicle and the images from each camera on the loading platform side.

The present invention has been made to solve these technical problems, and an object is to provide a vehicle that allows achieving appropriate driving assist for different types of loading platforms.

### Solution to Problem

A vehicle according to the present invention includes a tow vehicle, a loading platform, and a coupling part that couples the tow vehicle and the loading platform. The loading platform includes a storage unit that stores at least a loading platform type indicating a type of the loading platform. The tow vehicle includes a controller that acquires the loading platform type from the loading platform and performs a driving assist of the vehicle based on the acquired loading platform type.

In the vehicle according to the present invention, since the tow vehicle includes a controller that acquires the loading platform type from the loading platform and performs driving assist to the vehicle based on the acquired loading platform type, the driving assist tailored to condition of the loading platform can be performed. As a result, the appropriate driving assist can be achieved for different types of the loading platforms.

### Advantageous Effects of Invention

The invention can achieve the appropriate driving assist for the different types of loading platforms.

### BRIEF DESCRIPTION OF DRAWINGS

FIG. 1 is a side view illustrating a vehicle according to an embodiment.

FIG. 2A is an example illustrating mounting positions of first external sensors on a loading platform.

FIG. 2B is an example illustrating mounting positions of first external sensors on a loading platform.

FIG. 2C is an example illustrating mounting positions of first external sensors on a loading platform.

FIG. 3 is an example illustrating 360-degree sensing of the vehicle.

FIG. 4 is a block diagram illustrating a vehicle according to an embodiment.

FIG. 5 is a block diagram illustrating a fusion unit.

FIG. 6 is an example illustrating a data conversion table.

FIG. 7 is a block diagram illustrating an input enabling unit.

FIG. 8 is a flowchart illustrating a loading platform information acquisition.

FIG. 9 is a flowchart illustrating acquisition of CAN database information (CAN DB information).

FIG. 10 is a flowchart illustrating erasure of the loading platform information and the loading platform CAN database information (CAN DB information).

FIG. 11 is a flowchart illustrating a coordinate system integration.

FIG. 12 is a diagram illustrating a braking distance when an automatic emergency brake is activated.

FIG. 13 is a block diagram illustrating an automatic emergency brake controller.

FIG. 14 is a block diagram illustrating an automatic emergency brake warning brake table.

FIG. 15 is a flowchart illustrating an automatic emergency brake control.

FIG. 16 is a diagram illustrating a distance from a following vehicle during a lane-change.

FIG. 17 is a block diagram illustrating a lane-change collision mitigation controller.

FIG. 18 is a block diagram illustrating a steering control table.

FIG. 19 is a flowchart illustrating a collision mitigation control during lane-change.

FIG. 20 is an example in which a curve warning deceleration control is applied.

FIG. 21 is a block diagram illustrating a curve warning deceleration controller.

FIG. 22 is a block diagram illustrating a curve warning brake table.

FIG. 23 is a flowchart illustrating a curve warning deceleration control.

FIG. 24 is a block diagram illustrating a vehicle management system using OTA.

### DESCRIPTION OF EMBODIMENTS

The following describes embodiments of vehicles of the present invention with reference to the drawings. In the following description, the left/right and front/rear directions and positions are based on the line of sight of the vehicle driver. To avoid complications in the description, the “first external sensor” and the “second external sensor” may be referred to collectively as the “external sensor.”

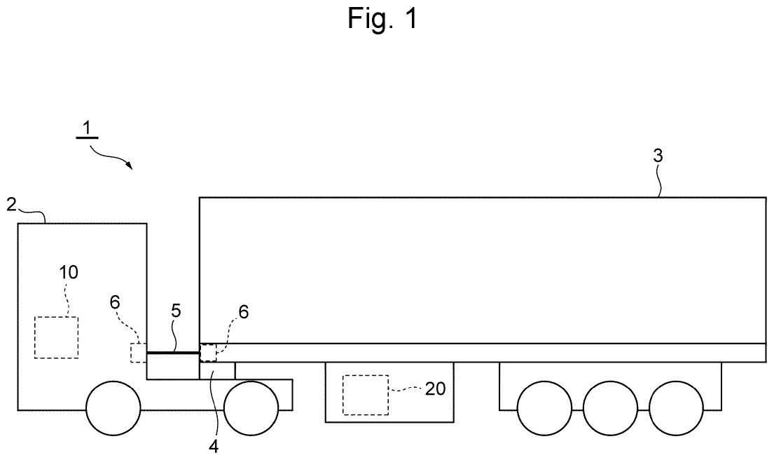

FIG. 1 is a side view illustrating a vehicle according to an embodiment. A vehicle 1 of the embodiment includes a tow vehicle 2 and a loading platform 3. The tow vehicle 2 and the loading platform 3 are coupled via a coupling part 4, which includes a coupler (not illustrated) provided on the tow vehicle 2 and a king pin (not illustrated) provided on the loading platform 3. A connector 6 is located on each of the tow vehicle 2 and the loading platform 3. These connectors 6 are electrically connected by a harness 5 provided on the loading platform 3 side. The connectors 6, 6 and the harness 5 provide power from the tow vehicle 2 side to the loading platform 3, and also transmit and receive signals between the tow vehicle 2 and the loading platform 3.

The loading platform 3 includes a management ECU (Electronic Control Unit) 20 that manages loading platform information including a loading platform type and the like, loading platform CAN data, and the like. The tow vehicle 2 includes an advanced driver assistance systems (ADAS) ECU 10 that performs driving assist for the vehicle 1.

The ADAS ECU 10 corresponds to the “controller” recited in the claims. The ADAS ECU 10 is constituted of a microcomputer that combines, for example, a central processing unit (CPU) to execute operations, a read only memory (ROM) as a secondary storage device that records programs for operations, and a random access memory (RAM) as a temporary storage device for storing the progress of operations and temporary control variables. Each control of the vehicle 1 is performed by executing the stored program. For example, the ADAS ECU 10 performs the driving assist that takes into account situations of different types of the loading platform 3 and achieves the driving assist by 360-degree sensing around the vehicle 1 via the external sensors mounted on each of the tow vehicle 2 and the loading platform 3.

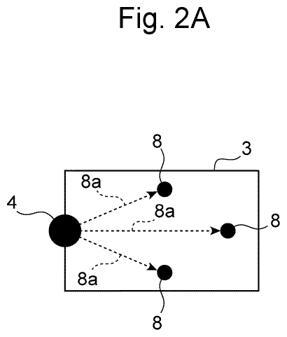

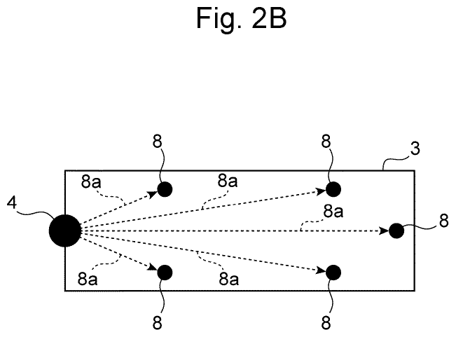

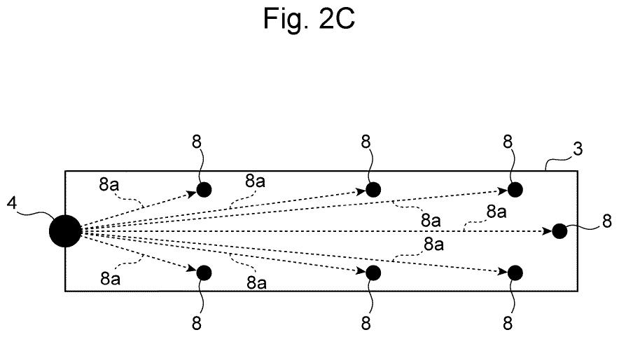

A first external sensors 8 mounted on the loading platform 3 are described here based on FIGS. 2A to 2C. FIG. 2A illustrates a loading platform 3 that is relatively small in size, FIG. 2C illustrates a loading platform 3 that is relatively large in size, and FIG. 2B illustrates a loading platform 3 that is in size between FIG. 2A and FIG. 2C.

As illustrated in FIGS. 2A to 2C, a plurality of first external sensors 8 are installed on each of the loading platforms 3. The first external sensor 8 includes, for example, a camera, a radar, a sonar, and the like, and detects an object around the loading platform 3 (more specifically, in both sides and behind the loading platform 3). The object in the vicinity includes, for example, another vehicle, a pedestrian, a road, a road marking, a street sign, a traffic signal, a guardrail, a median, roadside equipment, a utility pole, a building, and another obstacle.

The number of the first external sensors 8 may be, for example, three (see FIG. 2A), five (see FIG. 2B), seven (see FIG. 2C), or the like depending on the size of the loading platform 3. In FIGS. 2A to 2C, the relative distances of the respective first external sensors 8 relative to the coupling part 4 (that is, the distances from the coupling part 4 to the mounting positions of the first external sensors 8) are illustrated as relative coordinates 8a.

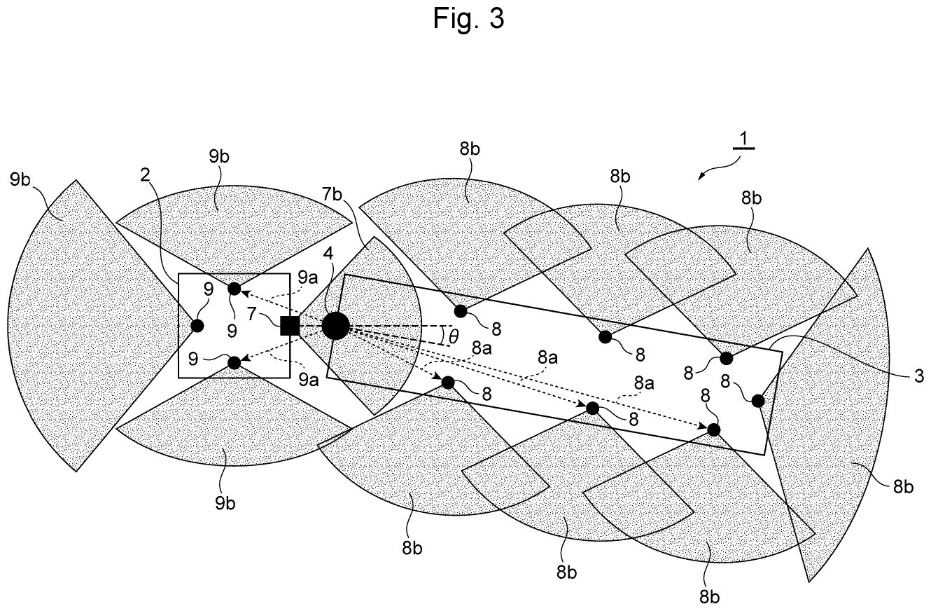

FIG. 3 illustrates an example of 360-degree sensing of the vehicle, and in FIG. 3, the loading platform 3 illustrated in FIG. 2C above is used. As illustrated in FIG. 3, seven first external sensors 8 are mounted on the loading platform 3, and three second external sensors 9 are mounted on the tow vehicle 2. Similarly to the first external sensors 8, the second external sensors 9 include a camera, a radar, a sonar, and the like and detects an object around the tow vehicle 2 (more specifically, in front of and in both sides of the tow vehicle 2). In addition, a rear camera 7 is mounted at a rear of the tow vehicle 2 to detect a relative angle θ between the tow vehicle 2 and the loading platform 3 at the coupling part 4. The rear camera 7 constitutes an “angle detector” as recited in the claims together with the loading platform angle detector 162 described below. The angle detector is not limited to the rear camera.

In FIG. 3, the relative distance of each of the second external sensors 9 relative to the coupling part 4 (that is, the distance from the coupling part 4 to the mounting position of the second external sensor 9) is illustrated as relative coordinates 9a. In addition, fan-shaped areas 8b and 9b indicate field of views (FOV) of the first external sensors 8 and the second external sensors 9, that is, the detection ranges (detection angle and detection distance) of the first external sensors 8 and the second external sensors 9. Furthermore, a fan-shaped area 7b indicates a field of view (FOV) of the rear camera 7, that is, the detection area of the rear camera 7.

Thus, in the vehicle 1 in which the tow vehicle 2 and the loading platform 3 are coupled via the coupling part 4, there are three coordinate systems: a sensor coordinate system based on a mounting position of each external sensor, a loading platform coordinate system based on the coupling part 4, and a tow vehicle coordinate system based on the coupling part 4. Therefore, in order to achieve 360-degree sensing of the vehicle 1, the detection data of each of the first external sensors 8 and the second external sensors 9 needs to be converted from their respective independent sensor coordinate systems to the common coordinate system (here, the tow vehicle coordinate system). Therefore, for the detection data of each of the second external sensors 9 mounted on the tow vehicle 2, a coordinate conversion from the sensor coordinate system of each of the second external sensors 9 directly to the tow vehicle coordinate system is performed.

On the other hand, the detection data of each of the first external sensors 8 mounted on the loading platform 3 needs to be subjected to a two-step coordinate conversion in which first, the detection data is once converted from the sensor coordinate system of each of the first external sensors 8 to the loading platform coordinate system and is then converted from the loading platform coordinate system to the tow vehicle coordinate system. When converting from the sensor coordinate system of each of the first external sensors 8 to the loading platform coordinate system, the relative coordinate 8a of each of the first external sensors 8 relative to the coupling part 4 are used. When converting from the loading platform coordinate system to the tow vehicle coordinate system, the relative angle θ between the tow vehicle 2 and the loading platform 3 at the coupling part 4 is used.

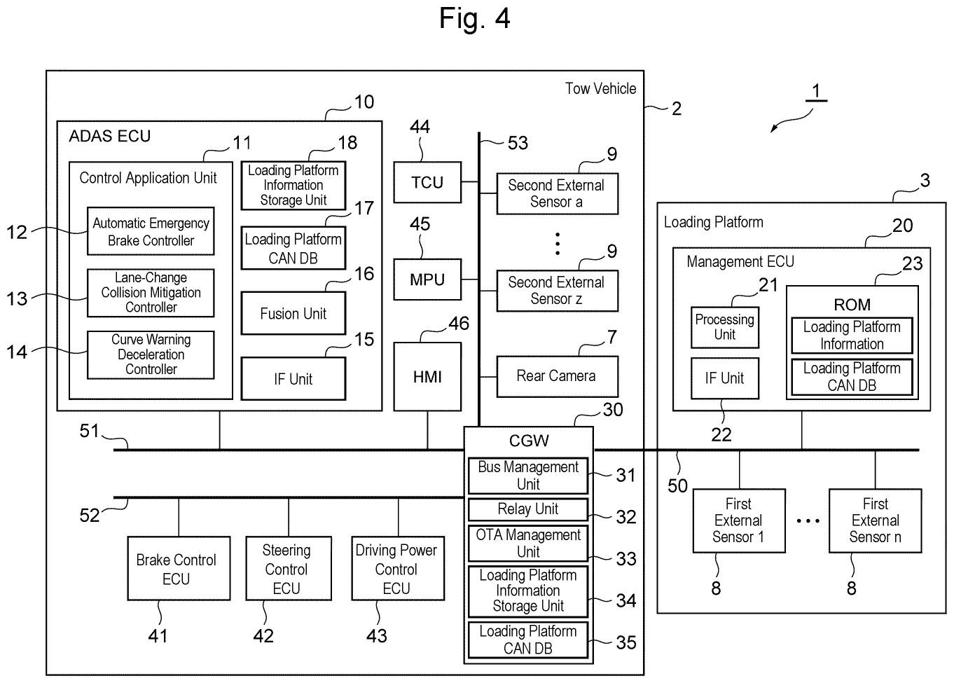

FIG. 4 is a block diagram illustrating the vehicle according to the embodiment. As illustrated in FIG. 4, in the vehicle 1, the tow vehicle 2 and the loading platform 3 are communicably connected to each other via a CAN bus 50. In addition to the ADAS ECU 10, the plurality of (a to z) second external sensors 9 and the rear cameras 7 described above, the tow vehicle 2 includes a plurality of CAN buses 51, 52, 53, a central gateway (CGW) 30 having a gateway function that transfers the CAN data to the appropriate CAN bus, a tele-communication unit (TCU) 44 that communicates with an external server and the like, a map processing unit (MPU) 45 that handles map information such as lanes and intersections, a human-machine interface (HMI) 46 that indicates information to the driver via voice and screen, a brake control ECU 41, a steering control ECU 42, and a driving power control ECU 43. The brake control ECU 41, the steering control ECU 42, and the driving power control ECU 43 are actuator-controlled.

The ADAS ECU 10 further includes an interface unit (IF unit) 15 that interfaces with the CAN bus 51, a fusion unit 16, a control application unit 11, a loading platform information storage unit 18 that stores loading platform information acquired from the loading platform 3, a loading platform CAN database (loading platform CAN DB) 17 that stores the loading platform CAN data acquired from the loading platform 3. The control application unit 11 includes, without limitation, an automatic emergency brake controller 12, a lane-change collision mitigation controller 13, and a curve warning deceleration controller 14 as application programs. The CGW 30 includes a bus management unit 31, a relay unit 32, an over-the-air (OTA) management unit 33, a loading platform information storage unit 34, and a loading platform CAN DB 35.

On the other hand, the loading platform 3 includes a management ECU 20 and a plurality (1 to n) of first external sensors 8, as described above. The management ECU 20 includes a processing unit 21 that performs each processing of the loading platform 3, an IF unit 22 that interfaces with the CAN bus 50, and a ROM 23. The ROM 23 corresponds to the “storage unit” recited in the claims and includes a nonvolatile memory. The ROM 23 stores each of the loading platform information and the loading platform CAN data.

Examples of the loading platform information stored in the ROM 23 are illustrated in Table 1. That is, the loading platform information includes the loading platform type, a diagnostics command for reading loading platform information for reading the loading platform information, size information of the loading platform, information of the first external sensors 8, and CAN database information for semantic interpretation (decoding) of the CAN data of the loading platform. Although not illustrated in Table 1, the loading platform information further includes the number of tires and a brake system and the like of the loading platform 3.

The loading platform type indicates the type of the loading platform 3. The diagnostics command for reading loading platform information describes a dedicated CAN ID for reading the loading platform information. When a CAN message with this CAN ID is transmitted by the towing side and received by the loading platform side, the management ECU of the loading platform replies with the loading platform information. The size information of the loading platform 3 includes the loading platform length, a loading platform width, a loading platform weight, a king pin height, an overall length of the coupling, and the like. The sensor information includes the number of the first external sensors 8 mounted on the loading platform 3, the identifier of each of the first external sensors 8, the coordinate of the mounting position of each of the first external sensors 8 (i=1 to N) relative to the coupling part 4, and the FOV of each of the first external sensors 8. Note that i (i=1 to N) is the identifier of each of the first external sensors 8. The sensor information is necessary information for achieving the 360-degree sensing of the vehicle 1. On the other hand, the CAN database information includes a format of the CAN database of the loading platform 3 and the diagnostics command for reading the loading platform CAN database (CAN DB information).

The size information of the loading platform 3, the first external sensor information, and the CAN database information for semantic interpretation (decoding) of the CAN data of the loading platform do not necessarily need to be stored in the ROM 23. When the loading platform type is known, the information may be acquired from an external server such as a data center based on the loading platform type. The diagnostics command for reading loading platform information and the diagnostics command for reading loading platform CAN data do not necessarily need to be stored in the ROM 23. When the type of the CAN data is known, these commands may be acquired from an external server such as a data center based on the type of the CAN data.

TABLE 1

| Loading platform type | * * * * | |
|---|---|---|
| CAN | Diagnostic command for | * * |
| | reading loading platform information | |
| Size | Loading platform weight | * * kg |
| | Loading platform length | * * mm |
| | Loading platform width | * * mm |
| | King pin height | * * mm |
| | Overall length of coupling | * * mm |
| First external | Number of first external sensors | * * |
| sensor (i = 1 . . . N) | Mounting position coordinate of | X[i] = * * mm |
| | first external sensor [i] relative to coupling part | Y[i] = * * mm |
| | FOV of first external sensor [1] | Detection angle |
| | | [i] = * * degree |
| | | Detection |
| | | distance [i] = * * m |
| CAN Database | CAN database format | * * |
| | Diagnostics command for reading CAN | * * |
| | database (CAN DB information) | |

Examples of the loading platform CAN database information (loading platform CAN DB) stored in the ROM 23 are illustrated in Table 2. The loading platform CAN database information is information that enables semantic interpretation (decoding) of all the CAN data output from the loading platform. The loading platform CAN database information is a table that describes where the CAN ID and data of the data (payload) of the CAN data of the loading platform is stored and what unit of data it is. Use of the table allows extracting necessary data from the loading platform CAN data. The loading platform CAN database information describes, for example, how the plurality of (j=1 . . . . N) first external sensors 8 are each stored in the CAN data. As the CAN ID and the data format of the first external sensors are known, the IF unit 15 of the ADAS ECU 10 can separate or extract the information of each of the first external sensors 8 from the loading platform CAN data.

TABLE 2

| CAN data | First external sensor CAN ID [j] | | * * |
|---|---|---|---|
| (j = | Data start bit [j] | | * * |
| 1 . . . N) | Data size bit [j] | | * * |
| | Byte Order [j] | | * * |
| | Data Type [j] | | * * |
| | Scaling [j] | | * * |
| | Offset [j] | | * * |
| | Data breakdown | Coordinate | * * |
| | | information [j, 1] to [j, k] | |
| | | Speed information | * * |
| | | [j, 1] to [j, k] | |

The fusion unit 16 first converts the detection data of each of the acquired first external sensors 8 from the sensor coordinate system of each of first external sensors 8 to the loading platform coordinate system, and further converts it from the loading platform coordinate system to the tow vehicle coordinate system to integrate the detection data of the first external sensors 8 and the detection data of the second external sensors 9 into the tow vehicle coordinate system. Next, the fusion unit 16 organizes the detection data of the first external sensors 8 and the detection data of the second external sensors 9 in a common tow vehicle coordinate system, and further reorders the data in accordance with rules such as a rule of time series. The fusion unit 16 then determines whether or not a detected object detected by the plurality of first external sensors 8 and second external sensors 9 are the same, and outputs the relative coordinate and the relative speed of the detected object relative to the vehicle 1. The relative coordinate of the detected object indicates, in other words, the relative position of the detected object.

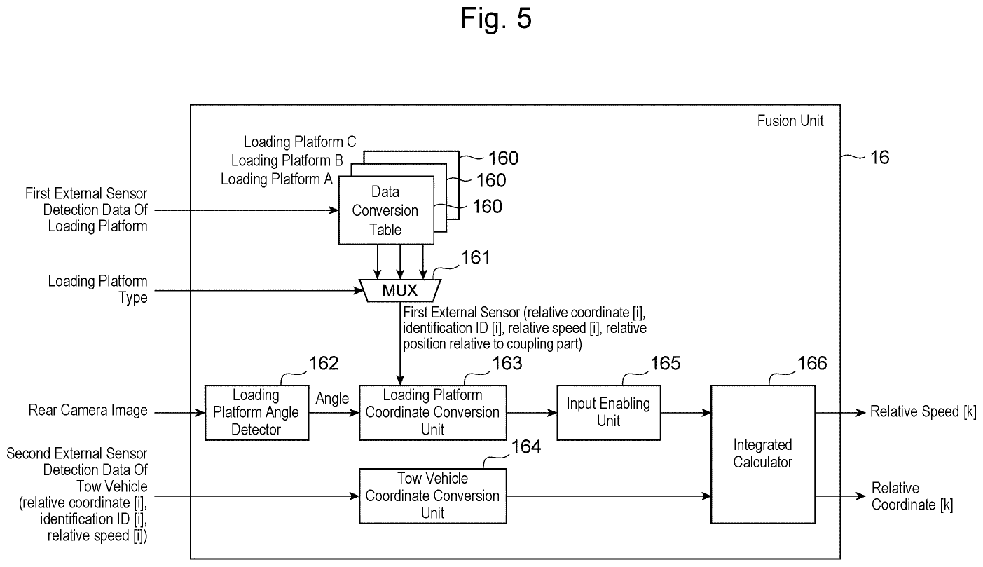

FIG. 5 is a block diagram illustrating the fusion unit. As illustrated in FIG. 5, the fusion unit 16 includes a plurality of data conversion tables 160, a multiplexer (MUX) 161, a loading platform angle detector 162, a loading platform coordinate conversion unit 163, a tow vehicle coordinate conversion unit 164, an input enabling unit 165, and an integrated calculator 166.

The data conversion table 160 is a table for converting the data format of the detection data of each of the first external sensors 8 to match the data format of the fusion unit 16. The data conversion table 160 is created for each of the loading platform types. Based on the loading platform type, the data conversion table 160 is downloaded via the over-the-air (OTA) from an external server, such as a data center, and stored in the fusion unit 16. Since the data conversion tables 160 are difference depending on the types of the loading platform, the data conversion tables 160 are independent of one another. In FIG. 5, the data conversion tables for three loading platform types (a loading platform A, a loading platform B, and a loading platform C) are illustrated.

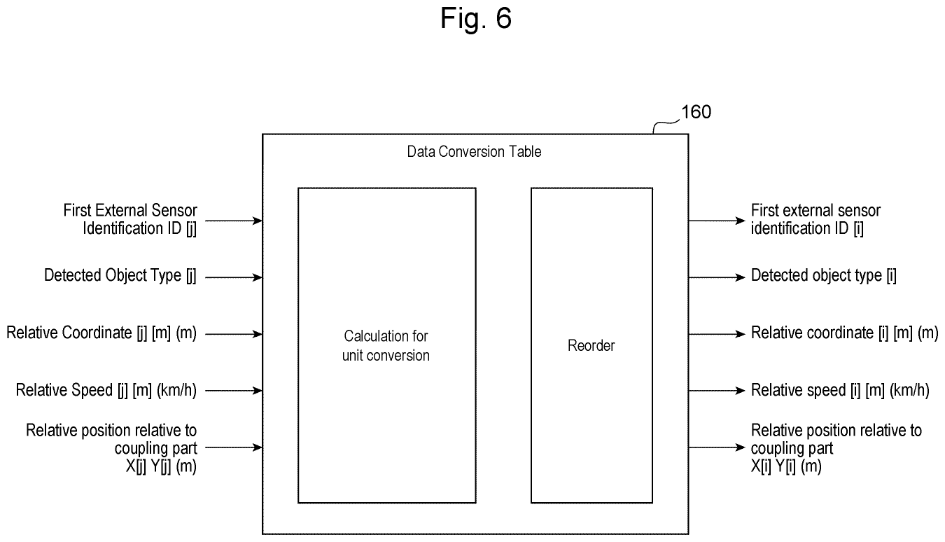

FIG. 6 illustrates an example of the data conversion table. Examples of input to the data conversion table 160 include the detection data separated by the IF unit 15 from the detection data of each of the first external sensors 8 mounted on the loading platform 3, which include the identification ID of each of the first external sensors 8, the type of the detected object detected by each of the first external sensors 8, the relative coordinate and the relative speed of the detected object detected by each of the first external sensors 8, and the relative position of each of the first external sensors 8 relative to the coupling part 4. The input to the data conversion table 160 is performed periodically.

In the data conversion table 160, calculations for unit conversion and reordering of the detection data are performed on the input data such that they can be used for subsequent calculations in the fusion unit 16. This results in unit conversion of the detection data of each of the first external sensors 8 and reordering of the data in ascending order, for example. On the other hand, the output from the data conversion table 160 includes, for example, the identification IDs of the i first external sensors 8, the type of the detected object detected by the i first external sensors 8, the relative coordinate and the relative speed of the detected object detected by the i first external sensors 8, the relative positions of the i first external sensors 8 relative to the coupling part 4.

Although the number of mounted first external sensors 8 differs depending on the type of loading platform 3 (in other words, the loading platform type), the number of valid first external sensors 8 is unknown to the integrated calculator 166 because it is unknown which loading platform 3 will be connected to the tow vehicle 2. Therefore, the integrated calculator 166 assumes that the information of the maximum number of the first external sensors 8 is always input, and performs the integration calculations. Then, the input enabling unit 165 is provided upstream side of the integrated calculator 166, and when the number of the first external sensors 8 is less than the maximum number, the surplus is treated as an invalid ID.

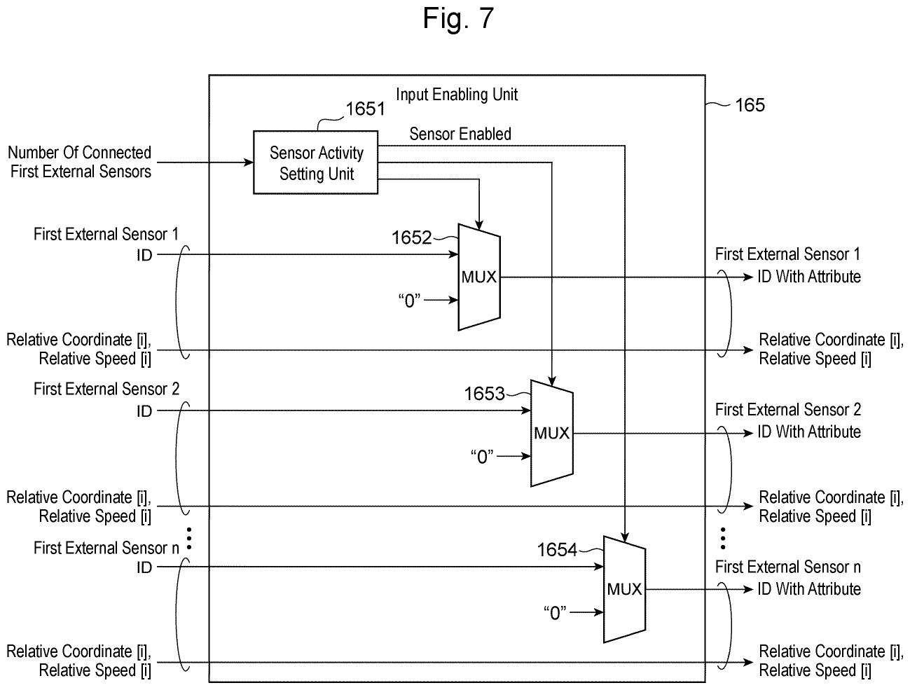

FIG. 7 is a block diagram illustrating the input enabling unit. The input enabling unit 165 includes a sensor activity setting unit 1651 and a multiplexer (MUX) 1652. The inputs to the input enabling unit 165 are the identification ID of each of the first external sensors 8, and the relative coordinate and the relative speed of the detected object detected by each of the first external sensors 8, on which the loading platform coordinate conversion unit 163 has performed the coordinate conversion. Here, the information on the number of connected first external sensors in the loading platform information is used. For example, when the number of the first external sensors 8 in the loading platform 3 is 5, since the data conversion table 160 has reordered the first external sensors 8 in ascending order, only 1 to 5 in the ascending order among the N inputs of the first external sensors 8 have their respective identification IDs passed through the MUX 1652, and 6 to N have their respective identification IDs set to zero to be output as invalid IDs, which are excluded from the calculation as the invalid IDs in the subsequent integrated calculator 166.

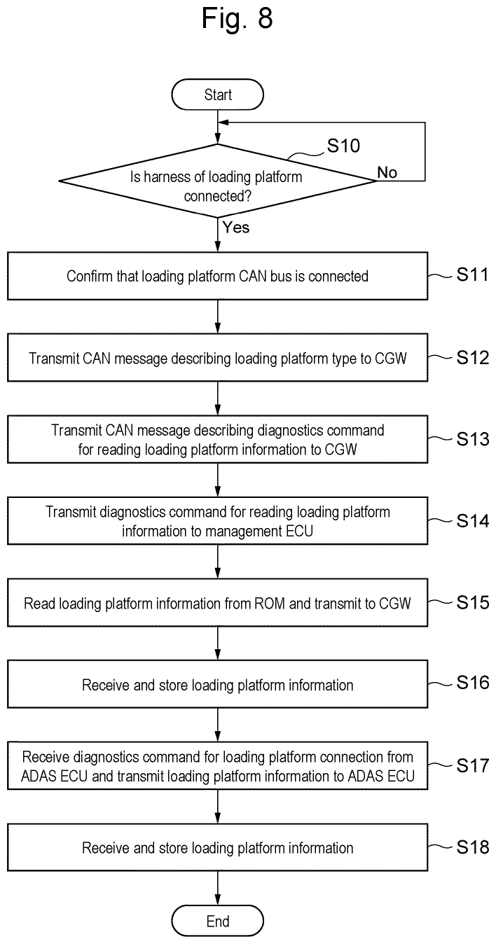

As described above, the tow vehicle 2 and the loading platform 3 are electrically connected by the harness 5. When the ignition is turned on by a driver of the vehicle 1, for example, the tow vehicle 2 acquires the loading platform information and the like from the loading platform 3. The acquired loading platform information is stored in the loading platform information storage unit 18, which is a nonvolatile memory, such that it is retained even after the power is cut off. The process of the loading platform information acquisition is described below based on FIG. 8.

FIG. 8 is a flowchart illustrating the loading platform information acquisition. As illustrated in FIG. 8, first, in Step S10, the vehicle 1 determines whether the harness 5 of the loading platform 3 is electrically connected to the connector 6 of the tow vehicle 2. When the harness 5 of the loading platform 3 is determined to be electrically connected, the vehicle 1 notifies the CGW 30 of the fact that it is electrically connected. The determination process in Step S10 is repeated until the harness 5 is determined to be electrically connected.

In Step S11 following Step S10, the bus management unit 31 of the CGW 30 confirms that the CAN bus 50 of the loading platform 3 is connected to the CGW 30 through the harness 5. This makes it ready for transmission of the CAN data from the loading platform 3 to the CGW 30.

In Step S12 following Step S11, the management ECU 20 of the loading platform 3 first reads the loading platform type in the loading platform information stored in the ROM 23. Next, the management ECU 20 transmits a CAN message to the CGW 30 with the loading platform type described in a data field of a specific CAN ID (for example, 0×0). The CAN message describing the loading platform type here corresponds, in other words, to the “CAN data of the first identifier” as recited in the claims. In this case, the CGW 30 causes the bus management unit 31 to decode the received CAN message describing the loading platform type, acquires the loading platform type, stores the acquired loading platform type, and transmits it to the ADAS ECU 10.

In Step S13 following Step S12, the management ECU 20 transmits a CAN message describing a diagnostics command for reading loading platform information in the data field of the specific CAN ID (for example, 0×1) to the CGW 30. The CAN message describing the diagnostics command for reading loading platform information here corresponds, in other words, to the “CAN data of the second identifier” as recited in the claims. Here, the diagnostics command for reading loading platform information describes the dedicated CAN ID for reading the loading platform information. When the CAN message with this CAN ID is transmitted by the towing side and received by the loading platform side, the management ECU of the loading platform replies with the loading platform information.

In Step S14 following Step S13, the CGW 30 causes the bus management unit 31 to decode the received CAN message above and transmits the diagnostics command for reading loading platform information to the management ECU 20 of the loading platform 3.

In Step S15 following Step S14, the management ECU 20 of the loading platform 3 reads the loading platform information stored in the ROM 23 based on the received diagnostics command for reading loading platform information and transmits the read-out loading platform information to the CGW 30.

In Step S16 following Step S15, the CGW 30 receives the loading platform information transmitted from the loading platform 3 and cause the loading platform information storage unit 34 to store it.

In Step S17 following Step S16, the CGW 30 transmits the loading platform information stored in the loading platform information storage unit 34 to the ADAS ECU 10. When the vehicle 1 is activated, the CGW 30 periodically receives and decodes a diagnostics command for the loading platform connection from the ADAS ECU 10. When the harness 5 of the loading platform 3 is electrically connected to the connector 6 of the tow vehicle 2, the CGW 30 transmits the loading platform information received from the loading platform 3 and stored in the loading platform information storage unit 34 to the ADAS ECU 10 as a response to the diagnostics command for the loading platform connection. On the other hand, when the harness 5 of the loading platform 3 is not electrically connected to the connector 6 of the tow vehicle 2, the CGW 30 transmits absence of the loading platform information to the ADAS ECU 10 as a response to the diagnostics command for the loading platform connection.

In Step S18 following Step S17, the ADAS ECU 10 receives the loading platform information transmitted from the CGW 30 and stores the received loading platform information in the loading platform information storage unit 18. This completes the process related to the acquisition of the loading platform information.

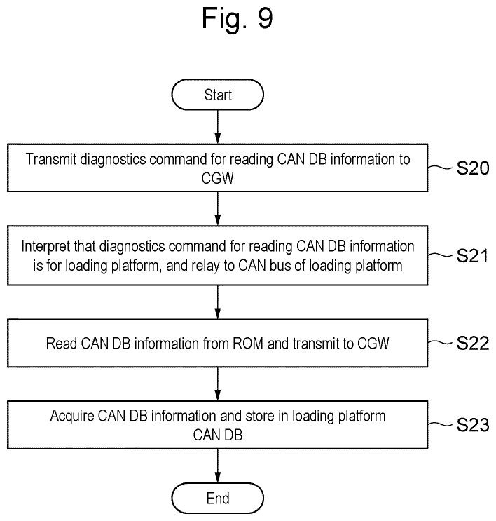

When the tow vehicle 2 acquires the loading platform information from the loading platform 3, the tow vehicle 2 further acquires the CAN database information (DB information) of the loading platform 3 in order to establish a vehicle communication for the loading platform information. This CAN database information (CAN DB information) is used by the IF unit to semantically interpret (decode) all the CAN data output from the loading platform and extract appropriate information (signals) from the CAN data. For example, as the CAN data from the loading platform, the detection data of the first external sensors 8 are packed in the corresponding CAN data, but decoding with the CAN database information allows deconstructing the packing data and extracting the signals such as the relative speed, the relative coordinate, and the like of the detected object detected by the first external sensors 8. Other CAN data is decoded in the same way. FIG. 9 illustrates how the CAN database information (CAN DB information) is stored within the ADAS ECU 10.

FIG. 9 is a flowchart illustrating the acquisition of the CAN database information (CAN DB information). Similarly to the loading platform information, the CAN database information (CAN DB information) is stored in the ROM 23 as a nonvolatile memory in the management ECU of the loading platform such that it is retained even after the power is cut off.

As illustrated in FIG. 9, first, in Step S20, the ADAS ECU 10 transmits a diagnostics command for reading CAN database (CAN DB information) included in the loading platform information retained in the loading platform information storage unit 18 to the CGW 30. The diagnostics command for reading CAN database (CAN DB information) is a CAN message for a diagnostics purpose to read the CAN database (CAN DB information). The information necessary to generate the diagnostics command for reading CAN database (CAN DB information) is stored in the loading platform information storage unit 18.

In Step S21 following Step S20, the CGW 30 first reads the CAN database information (CAN DB information) from the loading platform information storage unit 34 and causes the relay unit 32 to perform a data relay setting. Then, the CGW 30 interprets that the above-described diagnostics command for reading CAN database information (CAN DB information) is for the loading platform, and relays the diagnostics command for reading CAN data to the CAN bus 50 of the loading platform 3.

In Step S22 following Step S21, the management ECU 20 of the loading platform 3 receives the diagnostics command for reading CAN database information (CAN DB information), reads the CAN database information (CAN DB information) from the ROM 23, and transmits it to the CGW 30 via the CAN bus 50.

In Step S23 following Step S22, the CGW 30 relays the CAN database information (CAN DB information) transmitted from the loading platform 3 to the ADAS ECU 10. The ADAS ECU 10 acquires the relayed CAN database information (CAN DB information) and stores it in the loading platform CAN DB 17.

This completes the acquisition and the storage of the CAN database information (CAN DB information) in the ADAS ECU 10.

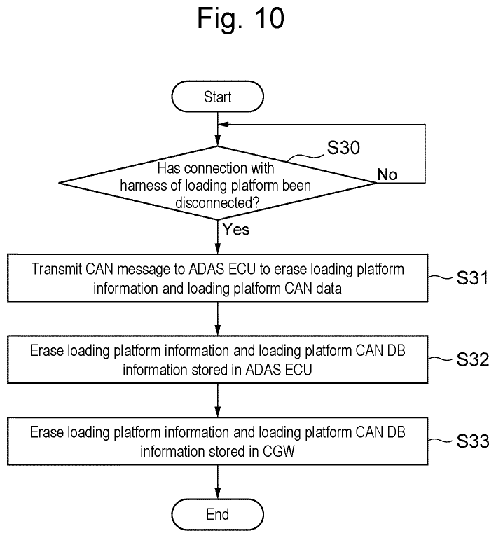

When the electrical connection between the connector 6 of the tow vehicle 2 and the harness 5 of the loading platform 3 is disconnected, the loading platform information and the loading platform CAN database information (CAN DB information) stored on the tow vehicle 2 side need to be erased. The loading platform information and the loading platform CAN database information (CAN DB information) are stored in the non-volatile memories, which can retain the data even if the power is cut off, of the CGW 30 and the ADAS ECU 10 (that is, the loading platform information storage unit 34 and the loading platform CAN DB 35 of the CGW 30, the loading platform information storage unit 18 and the loading platform CAN DB 17 of the ADAS ECU 10), respectively. Therefore, the data are erased from the nonvolatile memories by performing the erase process for both. The processes related to the erasure of the loading platform information and the loading platform CAN data are described below based on FIG. 10.

FIG. 10 is a flowchart illustrating the erasure of the loading platform information and the loading platform CAN database information (CAN DB information). As illustrated in FIG. 10, first, in Step S30, the vehicle 1 determines whether or not the electrical connection between the connector 6 of the tow vehicle 2 and the harness 5 of the loading platform 3 has been disconnected. The determination process in Step S30 is repeated until it is determined that the connection has been disconnected. When it is determined that the electrical connection between the connector 6 of the tow vehicle 2 and the harness 5 of the loading platform 3 has been disconnected, the vehicle 1 notifies the CGW 30 of the fact that the connection has been disconnected.

In Step S31 following Step S30, the CGW 30 transmits a CAN message to the ADAS ECU 10 to erase the loading platform information and the loading platform CAN database information (CAN DB information).

In Step S32 following Step S31, the ADAS ECU 10 receives the above-described CAN message from the CGW 30 and erases the loading platform information stored in the loading platform information storage unit 18 and the loading platform CAN database information (CAN DB information) stored in the loading platform CAN DB 17.

In Step S33 following Step S32, the CGW 30 erases the loading platform information stored in the loading platform information storage unit 34 and the loading platform CAN database information (CAN DB information) stored in the loading platform CAN DB 35. This completes the erasure of the loading platform information and the loading platform CAN database information (CAN DB information). Accordingly, when the electrical connection between the connector 6 of the tow vehicle 2 and the harness 5 of the loading platform 3 is disconnected, the loading platform information and the loading platform CAN database information (CAN DB information) stored in the ADAS ECU 10 and the CGW 30 are erased. Thus, when another loading platform is electrically connected next time, the use of incorrect loading platform information and loading platform CAN database information (CAN DB information) can be avoided. The incorrect information of the loading platform connected to the tow vehicle 2 is not used.

As described using FIGS. 8 and 9, the ADAS ECU 10 stores the loading platform information and the loading platform CAN database information (CAN DB information), and the ADAS ECU 10 can use the loading platform CAN database information (CAN DB information) to perform semantic interpretation (decoding) of the CAN data from the loading platform. For example, decoding with the loading platform CAN database information (CAN DB information) acquires information such as the relative speed and the relative coordinate of the detected object detected by the first external sensors 8 from the CAN data including the information of the first external sensors 8, and acquires information such as the number of the first external sensors 8 and the relative coordinates of the first external sensors 8 relative to the coupling part 4 based on the loading platform information.

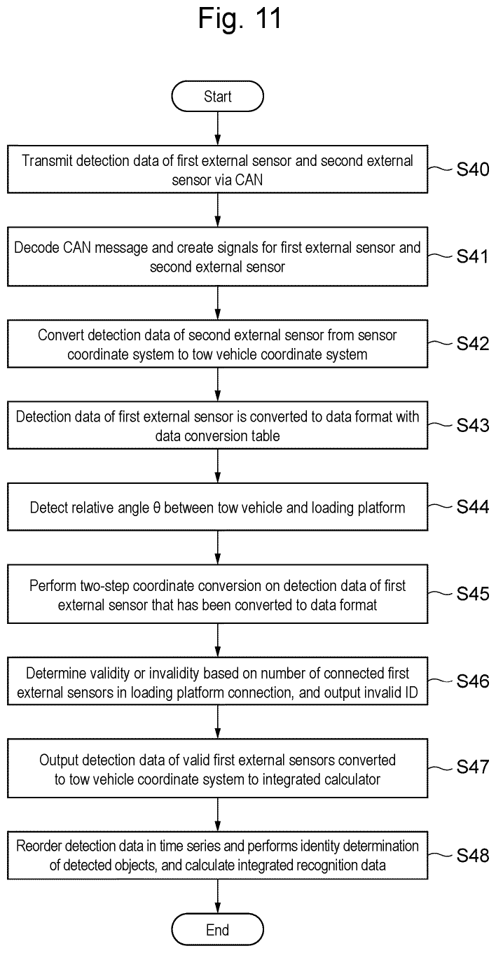

Based on FIG. 11, the following describes that the fusion unit 16 integrates the detection data of each of the first external sensors 8 mounted on the loading platform 3 and the detection data of each of the second external sensors 9 mounted on the tow vehicle 2 from their respective sensor coordinate systems into the common tow vehicle coordinate system (hereafter, referred to as a coordinate system integration) to achieve the 360-degree sensing.

FIG. 11 is a flowchart illustrating the coordinate system integration. As illustrated in FIG. 11, first, in Step S40, each of the second external sensors 9 mounted on the tow vehicle 2 and each of the first external sensors 8 mounted on the loading platform 3 periodically transmit their respective detection data to the CGW 30 via the CAN buses 50 and 53.

In Step S41 following Step S40, the IF unit 15 of the ADAS ECU 10 decodes the CAN message using the CAN data of the loading platform 3 and the tow vehicle 2, and creates signals of the detection data of the first external sensors 8 and the detection data of the second external sensors 9. The signals here refer to the relative coordinates, the relative speed, and the like of the detected object detected by each of the first external sensors 8 and the second external sensors 9, and are based on the respective sensor coordinate systems.

In Step S42 following Step S41, the tow vehicle coordinate conversion unit 164 converts the detection data of the second external sensors 9 of the tow vehicle 2 from the sensor coordinate system to the tow vehicle coordinate system. The converted detection data are input to the integrated calculator 166.

In Step S43 following Step S42, the detection data of the first external sensors 8 of the loading platform 3 are converted to the data format of the tow vehicle 2 side (in other words, the data format is converted) with the data conversion table 160 created for each of the loading platform types, and further selected based on the loading platform type in a MUX 161.

In Step S44 following Step S43, the loading platform angle detector 162 detects the relative angle θ between the tow vehicle 2 and the loading platform 3 based on an image captured by the rear camera 7.

In Step S45 following Step S44, the loading platform coordinate conversion unit 163 performs a two-step coordinate conversion on the detection data of the first external sensors 8 that have been converted to the data format in Step S43. In the first step, the relative position of the first external sensor 8 relative to the coupling part 4 is used to convert it from the sensor coordinate system of the first external sensor 8 to the loading platform coordinate system. In the second step, the relative angle θ between the tow vehicle 2 and the loading platform 3 is used to convert it from the loading platform coordinate system to the tow vehicle coordinate system.

In Step S46 following Step S45, the input enabling unit 165 determines whether the first external sensor 8 is valid or invalid based on the number of connected first external sensors 8 in the loading platform 3, and further outputs an invalid ID regarding the invalid first external sensor 8. Although not specifically limited, as an output of the data conversion table 160, when the detection results of the first external sensors 8 are arranged in ascending order from the valid ones, for example, when the number of the total detection results of the i first external sensors 8 are k, then 1 to k are output as the valid IDs and the rest as the invalid IDs.

In Step S47 following Step S46, the input enabling unit 165 outputs the detection data of the valid first external sensors 8, which have been converted to the tow vehicle coordinate system, to the integrated calculator 166 as information on the loading platform 3 side.

In Step S48 following Step S47, the integrated calculator 166 uses the detection data of the valid first external sensors 8 output from the input enabling unit 165 and the detection data of the second external sensors 9 converted to the tow vehicle coordinate system by the tow vehicle coordinate conversion unit 164, reorders these detection data in time series and performs the identity determination of the detected object, and calculates the integrated recognition data. This completes the coordinate system integration.

In the vehicle 1 of the embodiment, the tow vehicle 2 acquires the loading platform type from the loading platform 3 and achieves the 360-degree sensing based on the acquired loading platform type. For a different types of loading platform, the 360-degree sensing is based on the sensor information attached to each loading platform. Specifically, the 360-degree sensing of the vehicle 1 can be achieved by integrating the detection data of each of the first external sensors 8 of the loading platform 3 and the detection data of each of the second external sensors 9 of the tow vehicle 2 into the common tow vehicle coordinate system in the fusion unit 16 of the tow vehicle 2.

Furthermore, the 360-degree sensing of the vehicle 1 makes it possible to achieve application of various advanced driving assists on the vehicle 1. In this case, the vehicle 1 needs to change the control characteristics in the loading platform coupling while taking the characteristics of the different types of the loading platforms 3 into account. The following exemplary describes the applications of the advanced driving assists: an automated emergency brake assist, a lane-change collision mitigation assist, and a curve warning deceleration assist.

### [Automatic Emergency Brake Assist]

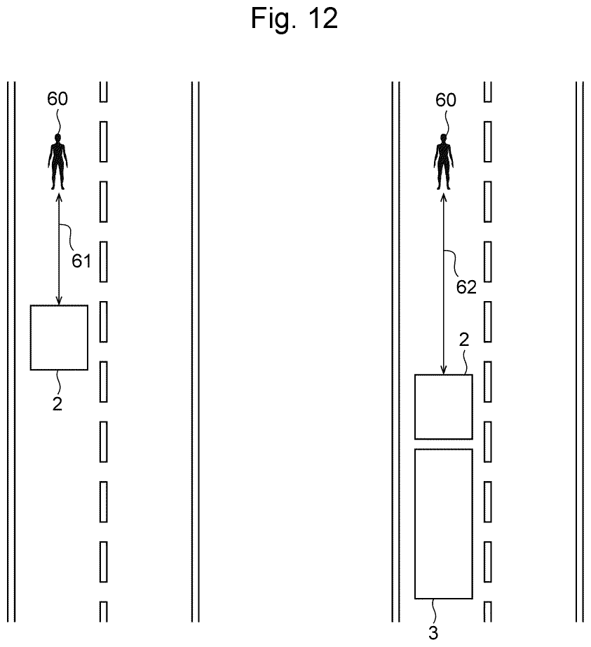

FIG. 12 illustrates a braking distance when an automatic emergency brake is activated. In FIG. 12, the left side and the right side illustrate a case where the tow vehicle 2 alone and a case where the loading platform 3 is coupled to the tow vehicle 2 (hereinafter referred to as “loading platform coupling”), respectively. As illustrated in FIG. 12, the braking distance to a pedestrian 60 when traveling at the same traveling speed is different between the case of the tow vehicle 2 alone and the case of loading platform coupling. That is, a braking distance 62 in the case of the loading platform coupling is longer than a braking distance 61 in the case of the tow vehicle 2 alone.

Even in the case of the loading platform coupling, the length of the braking distance varies depending on the size of the loading platform 3 and the brake system. Therefore, in an automatic emergency brake control, an alarm activation time and a braking control method need to be changed according to whether the loading platform 3 is connected or not and according to the different loading platform information.

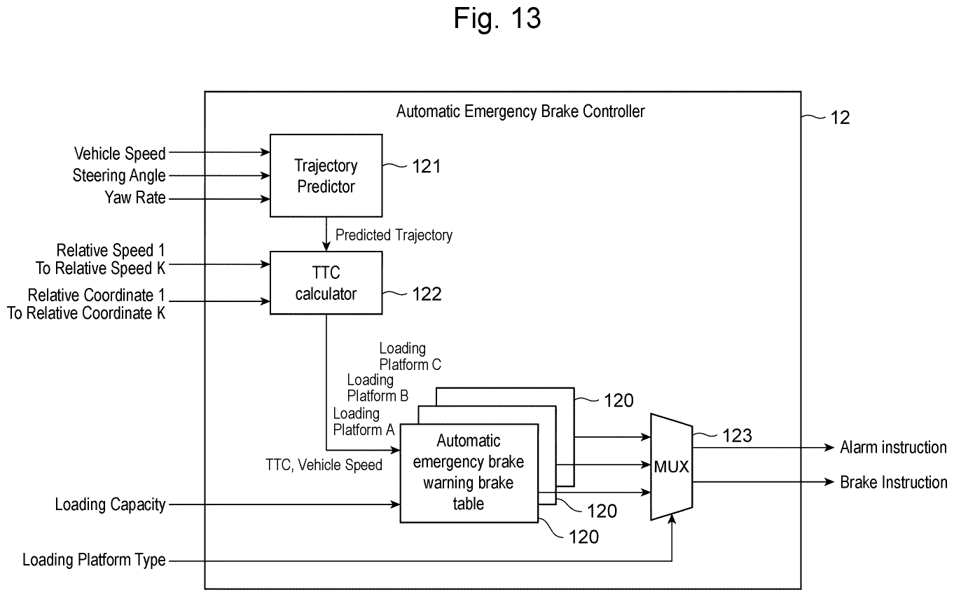

FIG. 13 illustrates a block diagram of the automatic emergency brake controller. As illustrated in FIG. 13, the automatic emergency brake controller 12 includes a trajectory predictor 121, a time to collision (TTC) calculator 122, a plurality of automatic emergency brake warning brake tables 120, and a MUX 123. The trajectory predictor 121 predicts a trajectory of the vehicle 1 based on the vehicle speed, the steering angle, and the yaw rate of the vehicle 1.

The TTC calculator 122 calculates the time to collision (TTC) with the detected object based on the trajectory predicted by the trajectory predictor 121 and the relative speed and the relative coordinate of the detected object (for example, a pedestrian in front of the vehicle) calculated by the fusion unit 16. The automatic emergency brake warning brake table 120 is a table for alarm instruction and brake instruction appropriate for the size of each of the loading platforms 3 and the brake system, and is created for each loading platform type. The MUX 123 corresponds to the “first multiplexer” recited in the claims and selects the automatic emergency brake warning brake table 120 based on the loading platform type.

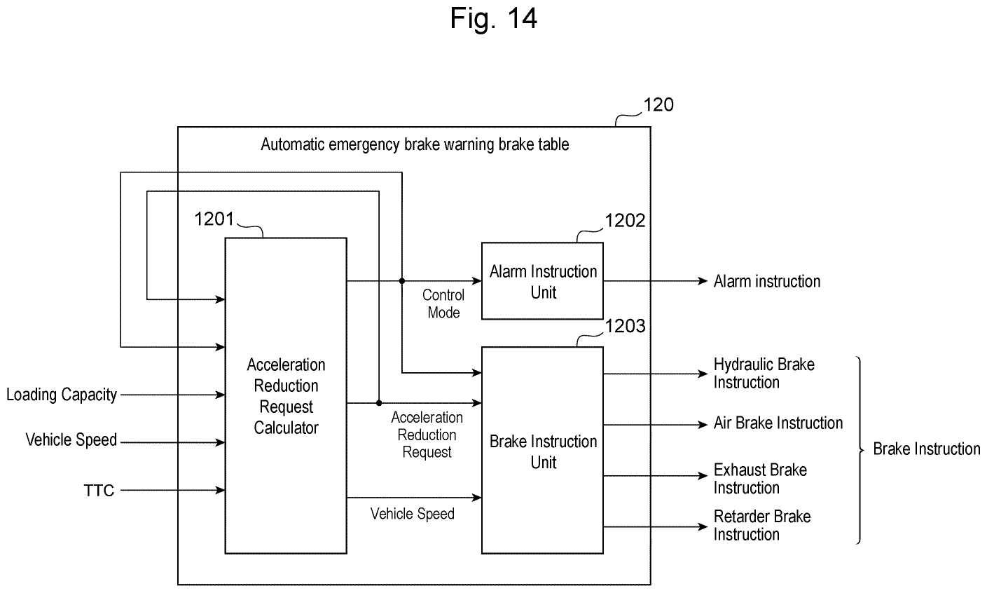

FIG. 14 is a block diagram illustrating the automatic emergency brake warning brake table. As illustrated in FIG. 14, the automatic emergency brake warning brake table 120 includes an acceleration reduction request calculator 1201, an alarm instruction unit 1202, and a brake instruction unit 1203. The acceleration reduction request calculator 1201 calculates the control mode and an acceleration reduction request based on the time to collision (TTC), the vehicle speed and a loading capacity of the vehicle 1. The control mode includes an alarm mode, a preliminary braking mode, an emergency braking mode, and the like. The calculated control mode and the acceleration reduction request are also used as input for the next calculation.

The alarm instruction unit 1202 outputs an alarm instruction when it is input that the vehicle is in alarm mode. The brake instruction unit 1203 performs an appropriate brake instruction among the brake systems of the tow vehicle 2 and the loading platform 3 based on the respective acceleration reduction requests and the vehicle speed in the preliminary braking mode or the emergency braking mode. The brake instruction includes a hydraulic brake instruction, an air brake instruction, an exhaust brake instruction, and a retarder brake instruction. The brake instruction is not limited thereto.

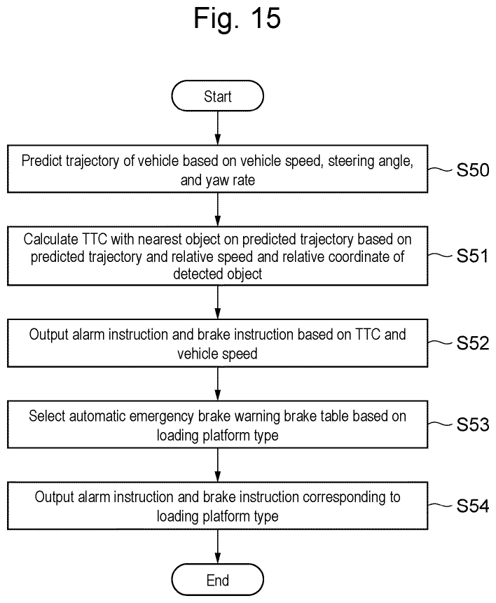

FIG. 15 is a flowchart illustrating the automatic emergency brake control. As illustrated in FIG. 15, first, in Step S50, the trajectory predictor 121 predicts the trajectory of the vehicle 1 based on the vehicle speed, the steering angle, and the yaw rate of the vehicle 1.

In Step S51 following Step S50, the TTC calculator 122 calculates the time to collision (TTC) with the nearest object on the predicted trajectory based on the trajectory predicted in Step S50 and the relative speed and the relative coordinate of the detected object calculated by the fusion unit 16.

In Step S52 following Step S51, the automatic emergency brake warning brake table 120 outputs the alarm instruction and the brake instructions to the MUX 123 based on the TTC calculated in Step S52 and the vehicle speed of the vehicle 1.

In Step S53 following Step S52, the MUX 123 selects the automatic emergency brake warning brake table 120 corresponding to the loading platform type based on the loading platform type.

In Step S54 following Step S53, the automatic emergency brake controller 12 outputs the alarm instruction and the brake instruction corresponding to the loading platform type using the selected automatic emergency brake warning brake table 120. This completes the process related to the automatic emergency brake control.

This allows achieving the 360-degree sensing of the vehicle 1 and the more appropriate automatic emergency brake assist by using the automatic emergency brake warning brake table 120 appropriate for the loading platform type.

### [Collision Mitigation Assist During Lane-change]

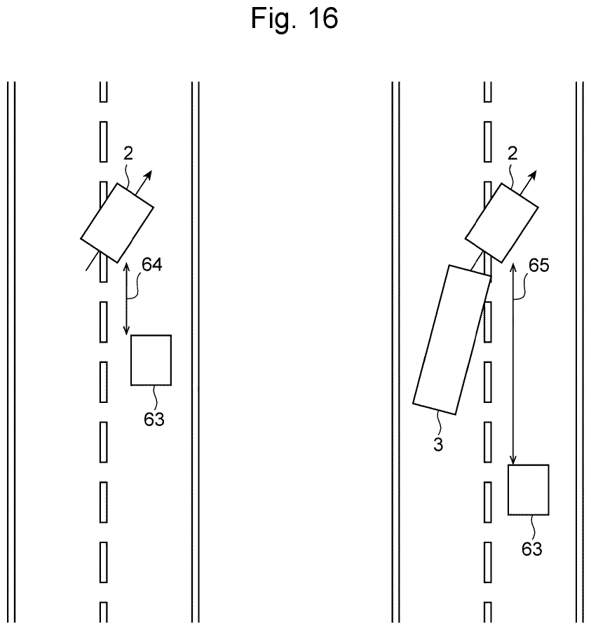

FIG. 16 illustrates the distance from a following vehicle during a lane-change. In FIG. 16, the left side and the right side illustrate a case of the tow vehicle 2 alone and a case of the loading platform coupling, respectively. As illustrated in FIG. 16, when traveling at the same speed, the allowable distance from a following vehicle 63 during the lane-change varies depending on whether there is the loading platform or not. In other words, an allowable distance 65 in the case of the loading platform coupling is longer than an allowable distance 64 in the case of the tow vehicle 2 alone. It is also necessary to take into account that even in the case of the loading platform coupling, the size of the loading platform changes the acceleration of the vehicle 1, and therefore, the lane-change requires more time.

The allowable distance d from the following vehicle during the lane-change is calculated by the following Formula (1).

$$d = ( {T}_{T} + {T}_{L} ) \times {V}_{r} \qquad ( 1 )$$

In Formula (1), T_{T} is the time to collision (unit: second), T_{L} is the lane change time (unit: second), and Vᵣ is the relative speed (unit: meter per second) to the following vehicle in the adjacent lane. T_{L} is a variable parameter because it is related to the loading platform length.

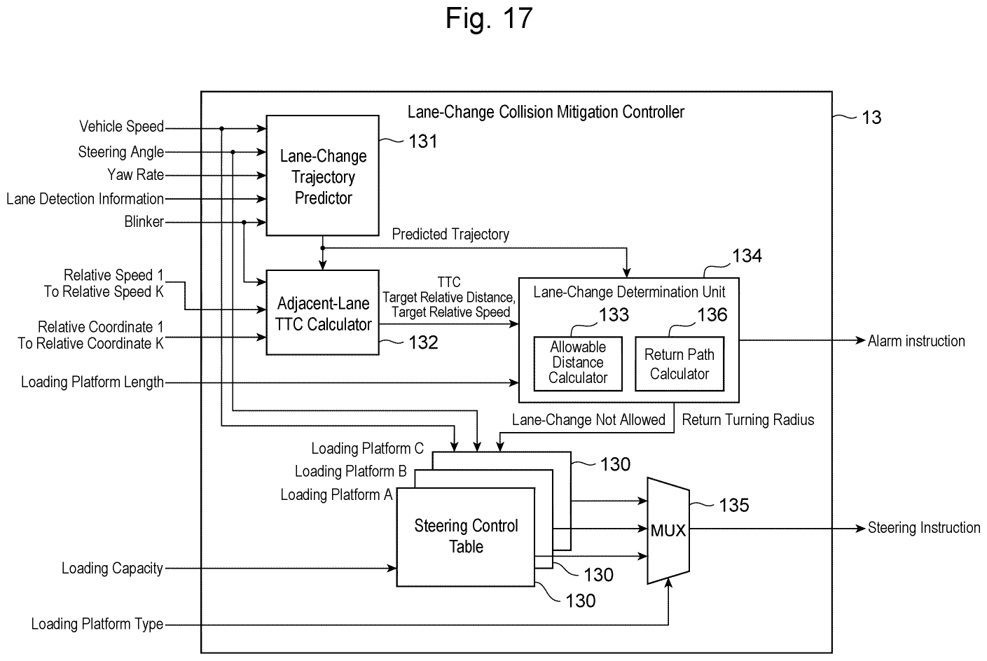

FIG. 17 is a block diagram illustrating the lane-change collision mitigation controller. As illustrated in FIG. 17, the lane-change collision mitigation controller 13 includes a lane-change trajectory predictor 131, an adjacent-lane TTC calculator 132, an allowable distance calculator 133, a lane-change determination unit 134, a return path calculator 136, a plurality of steering control tables 130, and a MUX 135.

The lane-change trajectory predictor 131 predicts the trajectory of the lane-change based on blinker information, the vehicle speed, the steering angle, the yaw rate, and the lane detection information of the vehicle 1. The lane detection information is acquired, for example, from the detection data of the second external sensor 9 mounted in front of the tow vehicle 2. The adjacent-lane TTC calculator 132 calculates the time to collision (TTC) with the following vehicle in the adjacent lane based on the trajectory predicted by the lane-change trajectory predictor 131, the relative speed and the relative coordinate of the detected object (in this case, the following vehicle) calculated by the fusion unit 16, and the blinker information of the vehicle 1.

The allowable distance calculator 133 calculates the allowable distance d based on the trajectory predicted by the lane-change trajectory predictor 131, the TTC calculated by the adjacent-lane TTC calculator 132, the vehicle speed of vehicle 1, the relative speed of the following vehicle in the adjacent lane to the vehicle 1, and the loading platform length.

Based on the allowable distance d calculated by the allowable distance calculator 133, the lane-change determination unit 134 determines whether the lane-change is allowed or not based on whether or not the relative position of the following vehicle in the adjacent lane with respect to the vehicle 1 is greater than the allowable distance d. When the lane-change is determined not to be allowed, the lane-change determination unit 134 performs a steering instruction for deterring the driver from steering to perform the lane-change when the lane-change is not allowed while issuing an alarm instruction. The return path calculator 136 calculates a return turning radius to return to the lane when the lane-change is determined not to be allowed.

The steering control table 130 is created for each loading platform type. This steering control table 130 is a table used to perform the steering instruction suitable for the size of each of the loading platforms 3 and the brake system in performing the steering instruction to deter the lane-change when the lane-change determination unit 134 has determined that the lane-change is not allowed. The MUX 135 corresponds to the “second multiplexer” recited in the claims and selects the steering control table 130 based on the loading platform type.

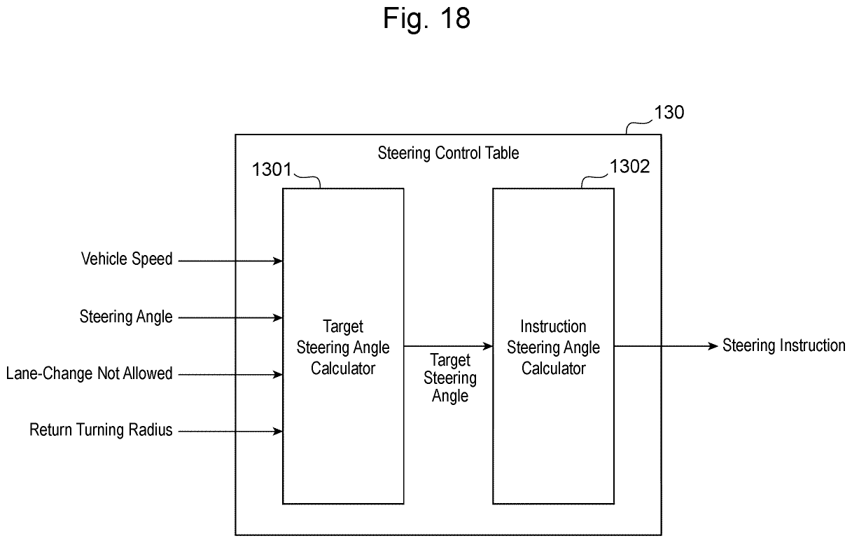

FIG. 18 is a block diagram illustrating the steering control table. As illustrated in FIG. 18, the steering control table 130 includes a target steering angle calculator 1301 and an instruction steering angle calculator 1302. The target steering angle calculator 1301 calculates the target steering angle to satisfy the return turning radius to return parallel to the lane when the lane-change has been determined not to be allowed based on the vehicle speed, the steering angle, lane-change inadvisable determination information, and return turning radius information of vehicle 1. The instruction steering angle calculator 1302 calculates the instruction steering angle such that the appropriate steering instruction is performed for the steering systems of the tow vehicle 2 and the loading platform 3.

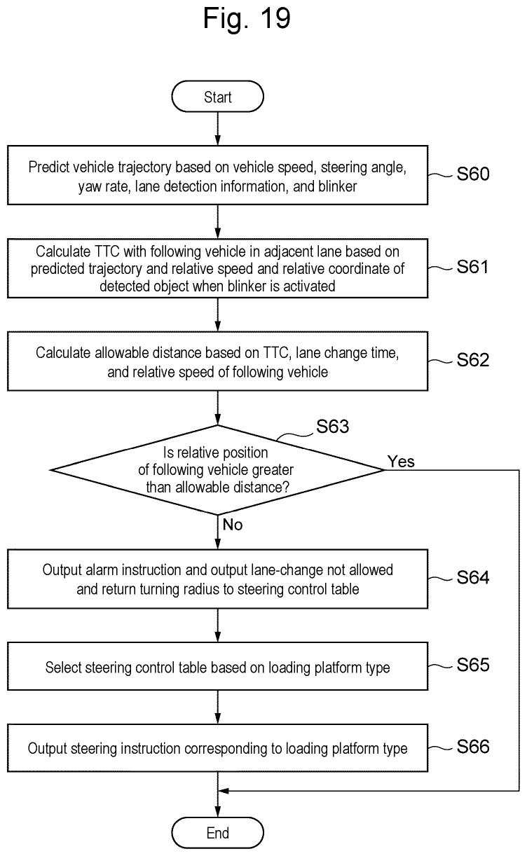

FIG. 19 is a flowchart illustrating the collision mitigation control during lane-change. As illustrated in FIG. 19, first, in Step S60, the lane-change trajectory predictor 131 predicts the trajectory of the vehicle 1 relative to the lane based on the vehicle speed, the steering angle, the yaw rate, the lane detection information, and the blinker information of the vehicle 1.

In Step S61 following Step S60, the adjacent-lane TTC calculator 132 calculates the time to collision (TTC) with the following vehicle traveling in the adjacent lane on the side indicated by the blinker based on the relative speed and the relative coordinate of the detected object (here, the following vehicle) calculated by the fusion unit 16 when the blinker is operated.

In Step S62 following Step S61, the allowable distance calculator 133 calculates the allowable distance d based on the time to collision (TTC) with the following vehicle, the lane change time from the predicted trajectory, and the relative speed of the following vehicle.

In Step S63 following Step S62, the lane-change determination unit 134 determines whether or not the relative position of the following vehicle in the adjacent lane is greater than the allowable distance d. When the relative position of the following vehicle is greater than the allowable distance d, the lane-change determination unit 134 determines that the lane-change is allowed, thereby terminating the processing. On the other hand, when the relative position of the following vehicle is equal to or less than the allowable distance d, the lane-change determination unit 134 determines that the lane-change is not allowed.

In Step S64 following Step S63, the lane-change determination unit 134 outputs the alarm instruction, calculates the turning radius to return to the lane, and further outputs the lane-change not allowed and the return turning radius to the steering control table 130.

In Step S65 following Step S64, the MUX 135 selects the steering control table 130 corresponding to the loading platform type based on the loading platform type.

In Step S66 following Step S65, the lane-change collision mitigation controller 13 outputs the steering instruction corresponding to the loading platform type using the selected steering control table 130. This completes the process related to the lane-change collision mitigation control.

This allows achieving the 360-degree sensing of the vehicle 1 and the more appropriate lane-change collision mitigation assist by using the steering control table 130 appropriate for the loading platform type.

### [Curve Warning Deceleration Assist]

The curve warning deceleration assist is to alert the driver when the vehicle 1 is traveling around a curve and the vehicle speed is too fast at the entrance of the curve according to a radius R of the curve, and to perform a deceleration control assist when a deceleration by the driver is still insufficient. Since the situation varies depending on the presence or absence of the loading platform, the size of the loading platform, and the brake system, the warning and the deceleration control methods need to be changed for each of the loading platform types.

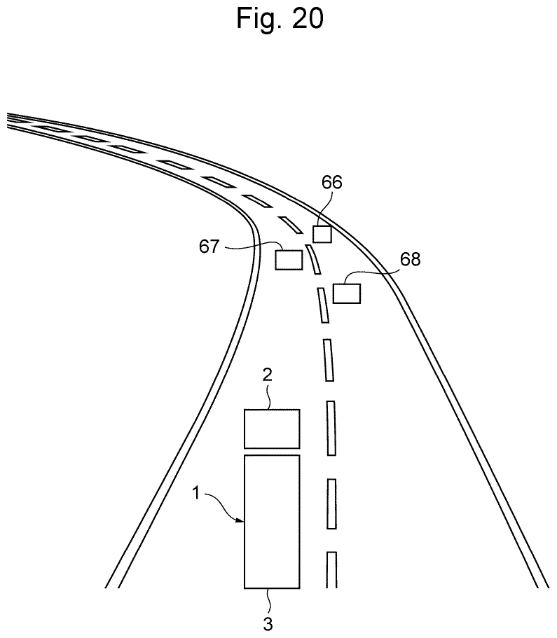

FIG. 20 illustrates an example where the curve warning deceleration control is applied. As illustrated in FIG. 20, the vehicle 1 is traveling near the entrance of the curve, and other vehicles 66, 67, 68 are traveling around the curve in front. The curve warning deceleration controller 14 acquires the radius R of the curve from a MPU 45, calculates the ideal speed at the curve entrance based on the radius R of the curve, the size of the loading platform, and the like, and controls the activation of the warning or the deceleration such that the ideal speed is achieved from the current vehicle speed.

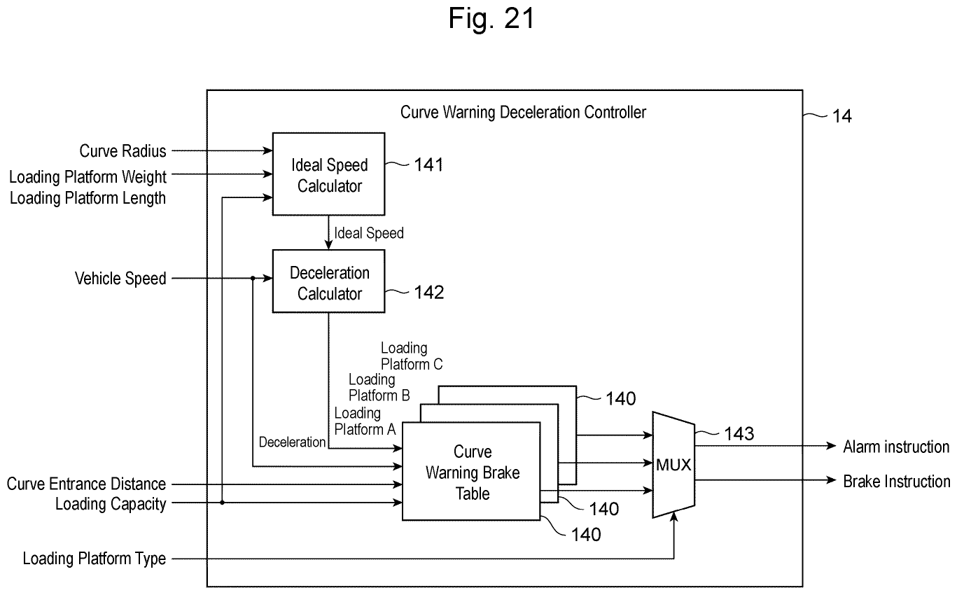

FIG. 21 is a block diagram illustrating the curve warning deceleration controller. As illustrated in FIG. 21, the curve warning deceleration controller 14 includes an ideal speed calculator 141, a deceleration calculator 142, a plurality of curve warning brake tables 140, and a MUX 143. The ideal speed calculator 141 calculates the ideal speed at the curve entrance based on the radius R of the curve, the loading platform weight and the loading platform length included in the loading platform information acquired from the MPU 45. The deceleration calculator 142 calculates the deceleration with each passing moment based on the ideal speed calculated by the ideal speed calculator 141 and the current vehicle speed.

The curve warning brake table 140 is created for each loading platform type. This curve warning brake table 140 is a table for performing a warning and a driving force control appropriate for each loading platform 3 size and the brake system based on the deceleration calculated by the deceleration calculator 142, the distance to the curve entrance acquired from the MPU 45, and the loading capacity of the vehicle 1. The MUX 143 corresponds to the “third multiplexer” recited in the claims and selects the curve warning brake table 140 based on the loading platform type. The driving force control of the curve warning brake table is a brake control. An accelerator control as an engine brake control may be included in the brake control.

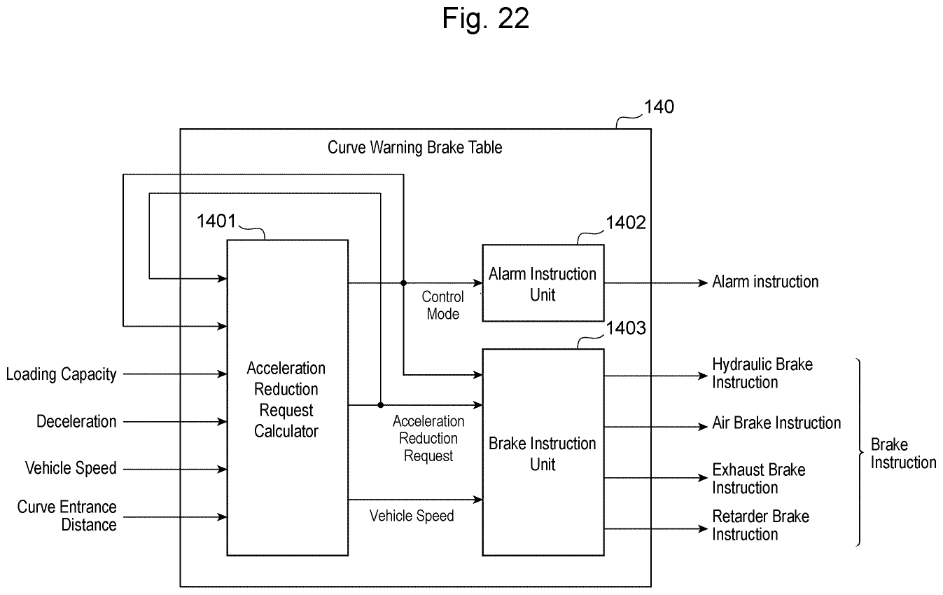

FIG. 22 is a block diagram illustrating the curve warning brake table. The curve warning brake table 140 includes an acceleration reduction request calculator 1401, an alarm instruction unit 1402, and a brake instruction unit 1403. The acceleration reduction request calculator 1401 calculates the control mode and the acceleration reduction request based on the vehicle speed of the vehicle 1, the deceleration calculated by the deceleration calculator 142, the loading capacity of the vehicle 1, and the distance to the curve entrance. The control modes include an alert mode, a preliminary braking mode, and an emergency braking mode. The calculated control mode and the acceleration reduction request are also used as input for the next calculation.

The alarm instruction unit 1402 outputs an alarm instruction when it is input that the vehicle is in the alarm mode. The brake instruction unit 1403 performs the appropriate brake instruction among the brake systems of the tow vehicle 2 and the loading platform 3 based on the acceleration reduction request and the vehicle speed in each of the preliminary braking mode and the emergency braking mode. The brake instruction includes a hydraulic brake instruction, an air brake instruction, an exhaust brake instruction, and a retarder brake instruction. The brake instruction is not limited thereto.

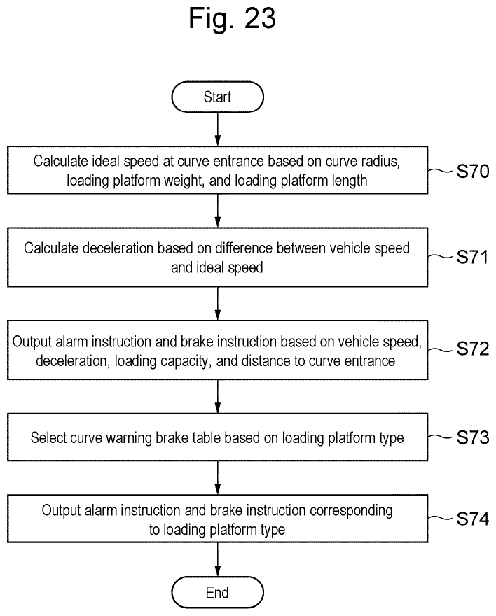

FIG. 23 is a flowchart illustrating the curve warning deceleration control. As illustrated in FIG. 23, first, in Step S70, the ideal speed calculator 141 calculates the ideal speed at the curve entrance based on the radius R of the curve, and the loading platform weight and the loading platform length included in the loading platform information, acquired from the MPU 45.

In Step S71 following Step S70, the deceleration calculator 142 calculates the deceleration based on the difference between the vehicle speed of the vehicle 1 and the ideal speed calculated in Step S70.

In Step S72 following Step S71, the curve warning brake table 140 outputs the alarm instruction and the brake instruction based on the vehicle speed of the vehicle 1, the deceleration, the load capacity of the vehicle 1, and the distance to the curve entrance.

In Step S73 following Step S72, the MUX 143 selects the curve warning brake table 140 corresponding to the loading platform type based on the loading platform type.

In Step S74 following Step S73, the curve warning deceleration controller 14 outputs the alarm instruction and the brake instruction corresponding to the loading platform type using the selected curve warning brake table 140. This completes the process related to the curve warning deceleration control.

This achieves the 360-degree sensing of the vehicle 1 and the more appropriate curve warning deceleration assist by using the curve warning brake table 140 appropriate for the loading platform type.

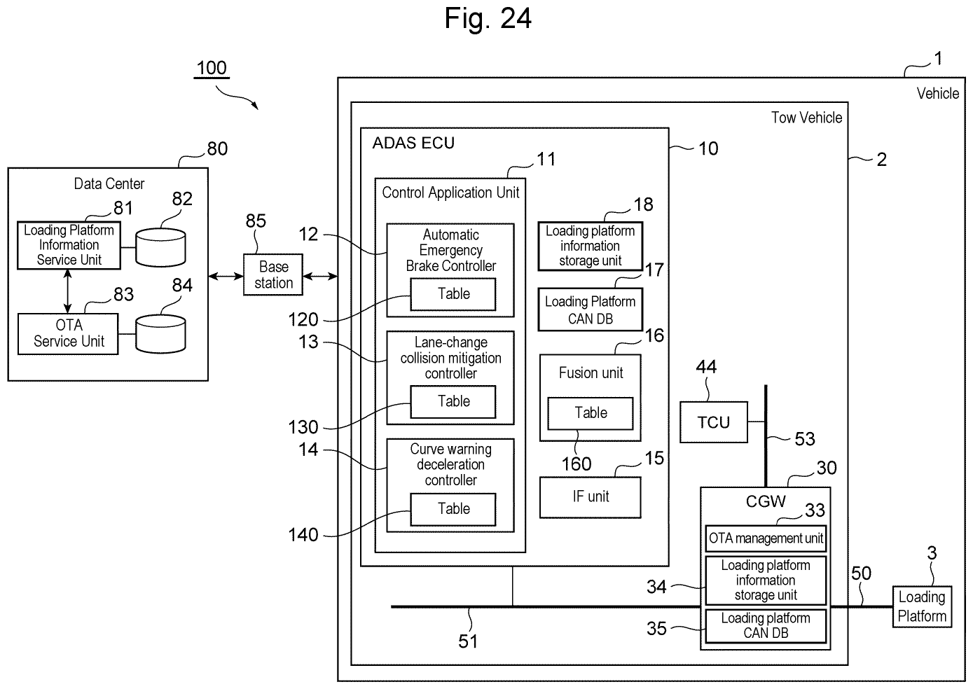

In the above-described embodiment, each of the tables is switched for each loading platform type, but these tables may be registered in a database of a data center for each loading platform type along with the loading platform information. In this case, the vehicle 1 may specify the loading platform type and the table format, request the data center to transmit the loading platform information and the table via the OTA, obtain loading platform information, and write data to the table in the vehicle 1. The following description is based on FIG. 24.

FIG. 24 illustrates a block diagram of a vehicle management system using the OTA. As illustrated in FIG. 24, a vehicle management system 100 includes a vehicle 1, a data center 80, and a base station 85 for communication. The data center 80 includes a loading platform information service unit 81, a loading platform information database 82, an OTA service unit 83, and an OTA program database 84 that stores OTA programs, customer information, and vehicle information, and the like.

The loading platform information service unit 81 uses the loading platform type and the table format to generate a table program by referring to the database. The OTA service unit 83 refers to the OTA program database 84 based on the customer information and the vehicle information to configure the table program as an OTA service. The OTA service unit 83 also delivers the table program to the vehicle 1 as the OTA. The tables here refer to the data conversion table 160, the automatic emergency brake warning brake table 120, the steering control table 130, and the curve warning brake table 140 described above.

The vehicle 1 transmits the customer information, the vehicle information, the loading platform type, and the table format to the data center 80 via a TCU 44, which has communication function, and receives the OTA program from the data center 80. The OTA management unit 33 of the CGW 30 then decodes the received OTA program and writes the data of each of the tables 120, 130, 140, and 160 to a predetermined address in the nonvolatile memory of the ADAS ECU 10. Although distributed in the figure, they may be located in a single nonvolatile memory. This allows data to be written to each table from the data center 80 via the OTA, thus allowing facilitated acquisition of the data in the tables.

At this time, it is preferred to acquire the loading platform information and the loading platform CAN data by writing the loading platform information and the loading platform CAN data corresponding to the loading platform type to the loading platform CAN DB 17 and the loading platform information storage unit 18 of the ADAS ECU 10 as OTA, which is not limited to the tables. Since the loading platform information can be the minimum necessary information such as the loading platform type, it may also be means of acquiring the minimum necessary information from a bar code attached to the loading platform 3.

This allows easily acquiring the data for each table, the loading platform information, and the loading platform CAN data from the data center 80 as necessary.

Although the embodiments of the present invention have been described in detail above, the present invention is not limited to the embodiments described above, and various design changes can be made to the extent that they do not depart from the spirit of the present invention recited in the claims.

### REFERENCE SIGNS LIST

1 Vehicle
2 Tow vehicle
3 Loading platform
4 Coupling part
5 Harness
6 Connector
7 Rear camera
8 First external sensor
9 Second external sensor
10 ADAS ECU
11 Control application unit
12 Automatic emergency brake controller
13 Lane-change collision mitigation controller
14 Curve warning deceleration controller
15 IF unit
16 Fusion unit
17 Loading platform CAN DB
18 Loading platform information storage unit
20 Management ECU
21 Processing unit
22 IF unit
23 ROM
30 CGW
31 Bus management unit
32 Relay Unit
33 OTA management unit
34 Loading platform information storage unit
35 Loading platform CAN DB
41 Brake control ECU
42 Steering control ECU
43 Driving power control ECU
44 TCU
45 MPU
46 HMI
50, 51, 52, 53 CAN bus

The invention claimed is:

1. A vehicle comprising:
a tow vehicle;
a loading platform; and
a coupling part that couples the tow vehicle and the loading platform,
wherein the loading platform includes a storage unit that stores at least a loading platform type indicating a type of the loading platform,
wherein the tow vehicle includes a controller that acquires the loading platform type from the loading platform and performs a driving assist of the vehicle based on the acquired loading platform type.

2. The vehicle according to claim 1,
wherein a plurality of first external sensors that detect an object around the loading platform are mounted on the loading platform,
wherein the storage unit of the loading platform stores the loading platform type, size information of the loading platform, information of the first external sensors, and loading platform information, the loading platform information including at least a brake system of the loading platform,
wherein the controller acquires the loading platform information and performs the driving assist of the vehicle based on the acquired loading platform information.

3. The vehicle according to claim 2,
wherein the tow vehicle further includes a plurality of second external sensors that detect an object around the tow vehicle and an angle detector that detects a relative angle between the tow vehicle and the loading platform,
wherein the controller acquires detection data of each first external sensor and detection data of each second external sensor, converts the acquired detection data of each second external sensor from a sensor coordinate system based on a mounting position of each second external sensor to a tow vehicle coordinate system based on the coupling part, converts the acquired detection data of each first external sensor from a sensor coordinate system based on the mounting position of each first external sensor to a loading platform coordinate system based on the coupling part, further converts the detection data from the loading platform coordinate system to the tow vehicle coordinate system based on the relative angle detected by the angle detector, integrates the detection data of the first external sensors and the detection data of the second external sensors into the tow vehicle coordinate system, and calculates a relative position and a relative speed of an detected object relative to the vehicle based on the integrated detection data.

4. The vehicle according to claim 3,
wherein the controller includes a data conversion table created for each of the loading platform types, the data conversion table converting a data format of the detection data of the first external sensor into a data format of the tow vehicle coordinate system.

5. The vehicle according to claim 2,
wherein the loading platform further includes a harness for electrically connecting to the tow vehicle,
wherein the tow vehicle further includes a gateway communicating via a plurality of CAN buses, and
wherein when the harness is electrically connected to the tow vehicle, the gateway receives CAN data of a first identifier from the loading platform, decodes the CAN data of the first identifier to acquire the loading platform type, stores the acquired loading platform type, and transmits the acquired loading platform type to the controller.

6. The vehicle according to claim 5,
wherein when the harness is electrically connected to the tow vehicle, the gateway receives CAN data of a second identifier from the loading platform, decodes the CAN data of the second identifier to acquire a diagnostics command for reading loading platform information for reading the loading platform information, acquires the loading platform information based on the acquired diagnostics command for reading loading platform information, stores the acquired loading platform information, and transmits the acquired loading platform information to the controller.

7. The vehicle according to claim 6,
wherein when the harness is electrically disconnected from the tow vehicle, the gateway erases the stored loading platform information.

8. The vehicle according to claim 6,
wherein the controller transmits a diagnostics command of a loading platform connection to the gateway,
wherein the gateway decodes the diagnostics command of the loading platform connection, transmits absence of the loading platform information to the controller as a response of the diagnostics command of the loading platform connection when the harness is not electrically connected to the tow vehicle, and transmits the loading platform information as a response of the diagnostics command of the loading platform connection to the controller when the harness is electrically connected to the tow vehicle.

9. The vehicle according to claim 3,
wherein the controller further includes an automatic emergency brake controller,
wherein the automatic emergency brake controller includes:
a trajectory predictor that predicts a trajectory of the vehicle based on a vehicle speed, a steering angle, and a yaw rate of the vehicle;
a time to collision calculator that calculates a time to collision with the detected object based on a trajectory predicted by the trajectory predictor, and the relative position and the relative speed of the detected object calculated by the controller,
an automatic emergency brake warning brake table created for each of the loading platform types and for performing an alarm instruction and a brake instruction; and
a first multiplexer that selects the automatic emergency brake warning brake table based on the loading platform type.

10. The vehicle according to claim 3,
wherein the controller further includes a lane-change collision mitigation controller,
wherein the lane-change collision mitigation controller includes:
a lane-change trajectory predictor that predicts a trajectory of a lane change based on blinker information, a vehicle speed, a steering angle, a yaw rate, and lane detection information of the vehicle;
an adjacent-lane time to collision calculator that calculates a time to collision with a following vehicle on an adjacent lane based on the trajectory predicted by the lane-change trajectory predictor, the relative position and the relative speed of the detected object calculated by the controller, and the blinker information of the vehicle;
an allowable distance calculator that calculates an allowable distance based on the trajectory predicted by the lane-change trajectory predictor, the time to collision calculated by the adjacent-lane time to collision calculator, the vehicle speed of the vehicle, a relative speed of the following vehicle on the adjacent lane relative to the vehicle, and a loading platform length included in the loading platform information;
a lane-change determination unit that determines whether or not to allow a lane change based on the allowable distance calculated by the allowable distance calculator, a relative position of the following vehicle on the adjacent lane relative to the vehicle;
a steering control table created for each of the loading platform types and for performing a steering instruction to deter the lane change when the lane-change determination unit has determined that the lane change is not allowed; and
a second multiplexer that selects the steering control table based on the loading platform type.

11. The vehicle according to claim 2,
wherein the controller further includes a curve warning deceleration controller,
wherein the curve warning deceleration controller includes:
an ideal speed calculator that calculates an ideal speed at a curve entrance based on a radius of a curve and a loading platform weight and a loading platform length included in the loading platform information,
a deceleration calculator that calculates deceleration of the vehicle based on an ideal speed calculated by the ideal speed calculator and the vehicle speed of the vehicle;
a curve warning brake table created for each of the loading platform types and for performing an alarm instruction and a brake instruction; and
a third multiplexer that selects the curve warning brake table based on the loading platform type.

12. The vehicle according to claim 1,
wherein a plurality of first external sensors that detect an object around the loading platform are mounted on the loading platform,
wherein the controller acquires loading platform information including at least size information of the loading platform corresponding to the loading platform type, information of the first external sensors, and a brake system of the loading platform from an external server communicably connected to the vehicle, based on the acquired loading platform type,
wherein the controller performs a driving assist of the vehicle based on the acquired loading platform information.

13. The vehicle according to claim 9,
wherein the controller acquires data of the automatic emergency brake warning brake table corresponding to the loading platform type from an external server communicably connected to the vehicle.

14. The vehicle according to claim 10,
wherein the controller acquires data of the steering control table corresponding to the loading platform type from an external server communicably connected to the vehicle.

15. The vehicle according to claim 11,
wherein the controller acquires data of the curve warning brake table corresponding to the loading platform type from an external server communicably connected to the vehicle.
